(19) United States
(12) Patent Application Publication
(10) Pub. No.: US 2013/0057558 A1
(43) Pub. Date: Mar. 7, 2013

(54) MECHANICAL LAYER AND METHODS OF MAKING THE SAME

(71) Applicants: Chuan Pu, Foster City, CA (US); Yi Tao, San Jose, CA (US); Chandra S. Tupelly, San Ramon, CA (US); Kostadin D. Djordjev, San Jose, CA (US); Fan Zhong, Fremont, CA (US); Rihui He, San Jose, CA (US); Wenyue Zhang, San Jose, CA (US)

(72) Inventors: Chuan Pu, Foster City, CA (US); Yi Tao, San Jose, CA (US); Chandra S. Tupelly, San Ramon, CA (US); Kostadin D. Djordjev, San Jose, CA (US); Fan Zhong, Fremont, CA (US); Rihui He, San Jose, CA (US); Wenyue Zhang, San Jose, CA (US)

(73) Assignee: QUALCOMM MEMS Technologies, Inc., San Diego, CA (US)

(21) Appl. No.: 13/227,263

(22) Filed: Sep. 7, 2011

(51) Int. Cl. G06T 1/00; G06F 3/038; B05D 5/12; H02N 1/00

(52) U.S. Cl. 345/501; 310/300; 345/204; 427/123

(57) ABSTRACT

This disclosure provides systems, methods and apparatus for controlling a mechanical layer. In one aspect, an electromechanical systems device includes a substrate and a mechanical layer positioned over the substrate to define a gap. The mechanical layer is movable in the gap between an actuated position and a relaxed position, and includes a mirror layer, a cap layer, and a dielectric layer disposed between the mirror layer and the cap layer. The mechanical layer is configured to have a curvature in a direction away from the substrate when the mechanical layer is in the relaxed position. In some implementations, the mechanical layer can be formed to have a positive stress gradient directed toward the substrate that can direct the curvature of the mechanical layer upward when the sacrificial layer is removed.

### TECHNICAL FIELD

This disclosure relates to electromechanical systems.

### DESCRIPTION OF THE RELATED TECHNOLOGY

Electromechanical systems (EMS) include devices having electrical and mechanical elements, actuators, transducers, sensors, optical components (including mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography and/or other micromachining processes that etch away parts of substrates and/or deposited material layers, or that add layers to form electrical and electromechanical devices.

One type of EMS device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

### SUMMARY

The systems, methods and devices of the disclosure each have several innovative aspects, no single one of which is solely responsible for the desirable attributes disclosed herein.

One innovative aspect of the subject matter described in this disclosure can be implemented in an electromechanical systems device that includes a substrate and a mechanical layer positioned over the substrate. The mechanical layer is spaced from the substrate and defines one side of a gap between the mechanical layer and the substrate, and the mechanical layer is movable in the gap between an actuated position and a relaxed position. The mechanical layer includes a mirror layer, a cap layer and a dielectric layer disposed between the mirror layer and the cap layer. The mirror layer faces the gap. The mechanical layer is configured to have a curvature in a direction away from the substrate when the mechanical layer is in the relaxed position.

In some implementations, the mirror layer thickness dimension is greater than the cap layer thickness dimension by a factor ranging between about 1.1 to about 1.2. In some implementations, the cap layer includes cuts for reducing a stress of the cap layer relative to a stress of the reflective layer such that the mechanical layer curves in a direction away from the substrate.

Another innovative aspect of the subject matter described in this disclosure can be implemented as a method of manufacturing an electromechanical systems device, the mechanical layer having an actuated position and a relaxed position. The method includes forming a support structure over a substrate and forming a mechanical layer over the support structure and the substrate. Forming the mechanical layer includes forming a mirror layer, forming a dielectric layer over the mirror layer and forming a cap layer over the dielectric layer. The mirror layer is on a side of the mechanical layer facing the substrate. Forming the mechanical layer includes configuring the mechanical layer to have a curvature in a direction away from the substrate when the mechanical layer is in the relaxed position.

In some implementations, forming the mechanical layer includes forming the mirror and cap layers such that the mirror and cap layers each have a tensile stress with the tensile stress of the mirror layer greater than the tensile stress of the cap layer so as to curve the mechanical layer in a direction away from the substrate when the mechanical layer is in the relaxed position. In some implementations, the mirror layer thickness dimension is greater than the cap layer thickness dimension by about 50 Å to 100 Å.

Another innovative aspect of the subject matter described in this disclosure can be implemented as an electromechanical systems device including a substrate and a mechanical layer spaced from the substrate and defining one side of a gap between the mechanical layer and the substrate. The mechanical layer is movable in the gap between an actuated position and a relaxed position, and the mechanical layer includes means for directing the curvature of the mechanical layer in a direction away from the substrate when the mechanical layer is in the relaxed position such that a portion of the mechanical layer above a center of a pixel of the device is displaced from the substrate by about 10 nm to about 30 nm more than an average distance between the mechanical layer and the substrate over an optically active area of the device.

In some implementations, the curvature directing means includes a mirror layer, a cap layer and a dielectric layer disposed between the mirror and cap layers. The mirror layer faces the substrate and has a thickness dimension greater than a thickness dimension of the cap layer.

Another innovative aspect of the subject matter described in this disclosure can be implemented as a method of manufacturing a mechanical layer in an electromechanical systems device. The method includes forming a sacrificial layer over a substrate and forming a mechanical layer over the sacrificial layer and the substrate. Forming the mechanical layer includes forming a first layer over the sacrificial layer and a second layer over the first layer, wherein the first layer has a stress that is greater than a stress of the second layer such that the mechanical layer has a stress gradient that increases in the direction toward the substrate.

In some implementations, the first layer is a first dielectric sub-layer of the mechanical layer and the second layer is a second dielectric sub-layer of the mechanical layer.

In some implementations, forming the mechanical layer further includes forming a mirror layer before forming the first layer and forming a cap layer after forming the second layer.

Details of one or more implementations of the subject matter described in this specification are set forth in the accompanying drawings and the description below. Although the examples provided in this disclosure are primarily described in terms of electromechanical systems (EMS) and microelectromechanical systems (MEMS)-based displays, the concepts provided herein may apply to other types of displays, such as liquid crystal displays, organic light-emitting diode (“OLED”) displays and field emission displays. Other features, aspects and advantages will become apparent from the description, the drawings and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 shows an example of a flow diagram illustrating a manufacturing process for an interferometric modulator.

FIGS. 10A and 10B are graphs of mechanical layer position versus voltage for two examples of interferometric modulator devices.

FIGS. 11A-11L show examples of cross-sectional schematic illustrations of various stages in methods of making interferometric modulators according to various implementations.

FIGS. 12A and 12B show examples of system block diagrams illustrating a display device that includes a plurality of interferometric modulators.

Like reference numbers and designations in the various drawings indicate like elements, which may have certain structural or characteristic differences according to certain implementations.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device or system that can be configured to display an image, whether in motion (e.g., video) or stationary (e.g., still image), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (i.e., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS), microelectromechanical systems (MEMS) and non-MEMS applications), aesthetic structures (e.g., display of images on a piece of jewelry) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Electromechanical devices having a mechanical layer that curves away from an optical stack disposed on a substrate are disclosed. The mechanical layer can include a reflective layer facing the substrate, a dielectric layer over the reflective layer and a cap layer over the dielectric layer. During manufacture of the device, the mechanical layer can be deposited over a sacrificial layer, which can be subsequently removed to form a gap. Although in some implementations a portion of the mechanical layer can be substantially flat before the sacrificial layer is removed, the mechanical layer can be configured to curve away from the optical stack and substrate after removal of the sacrificial layer (which can be referred to as the “launch” of the mechanical layer). The launch of the mechanical layer upward and away from the substrate can be controlled in any suitable manner, including, for example, by selecting certain materials, thicknesses, stresses and/or geometries of the layers of the mechanical layer. For instance, in some implementations the mechanical layer can be formed to have a positive stress gradient directed toward the substrate that can direct the curvature of the mechanical layer upward when the sacrificial layer is removed. Directing the curvature of the mechanical layer away from the substrate can lead to an improvement in panel margin, contrast ratio, gamut and/or color saturation of a display that includes such devices. For example, it has been found that a displacement of the mechanical layer away from the substrate upon removal of the sacrificial layer in the range of about 10 nm to about 30 nm defined from the center of the mechanical layer to the average mechanical layer position can provide improved performance relative to a mechanical layer that is flat or curves downward towards the substrate after the sacrificial layer is removed.

Particular implementations of the subject matter described in this disclosure can be implemented to control the curvature and/or shape of the mechanical layer after removal of a sacrificial layer. Additionally, some implementations can be used to reduce the voltage needed to switch the mechanical layer between actuated and relaxed positions. Furthermore, some implementations can reduce stiction between the mechanical layer and the substrate and/or improve panel margin. Moreover, according to some implementations, optical properties of the display can be improved including, for example, an improvement in the dark state, contrast ratio, gamut and/or color saturation.

An example of a suitable EMS or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity. One way of changing the optical resonant cavity is by changing the position of the reflector.

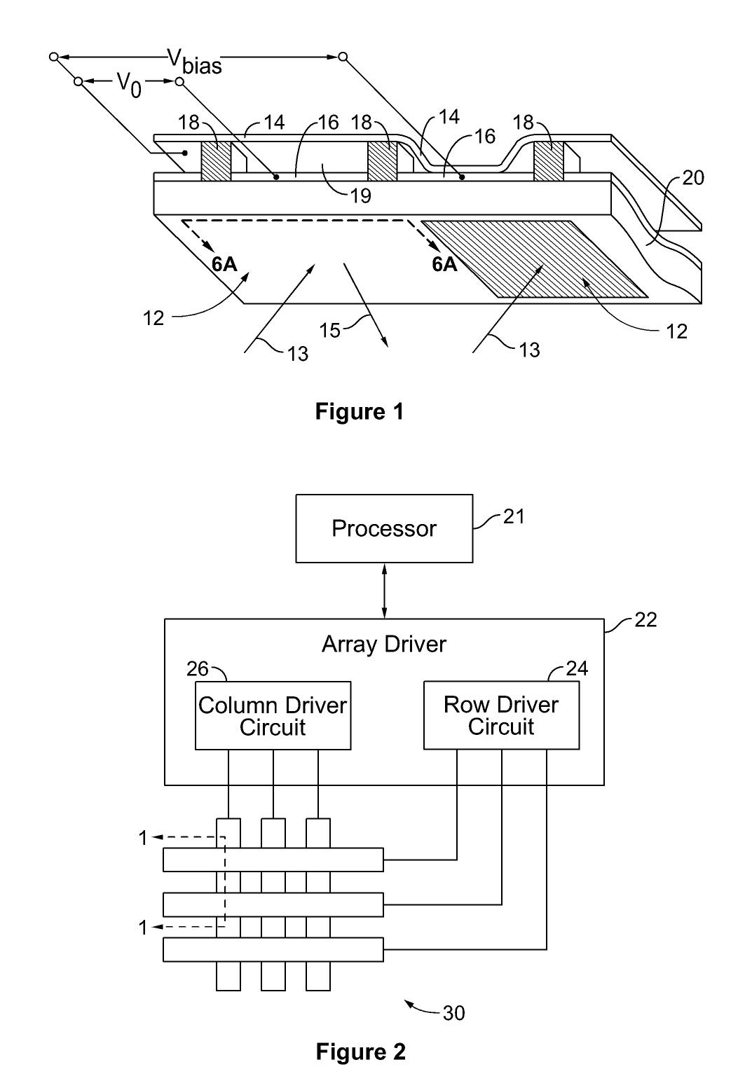

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, absorbing and/or destructively interfering light within the visible range. In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage Vₒ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by one having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, such as chromium (Cr), semiconductors and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and electrical conductor, while different, electrically more conductive layers or portions (e.g., of the optical stack 16 or of other structures of the IMOD) can serve to bus signals between IMOD pixels. The optical stack 16 also can include one or more insulating or dielectric layers covering one or more conductive layers or an electrically conductive/optically absorptive layer.

In some implementations, the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be approximately less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, a voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example, a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

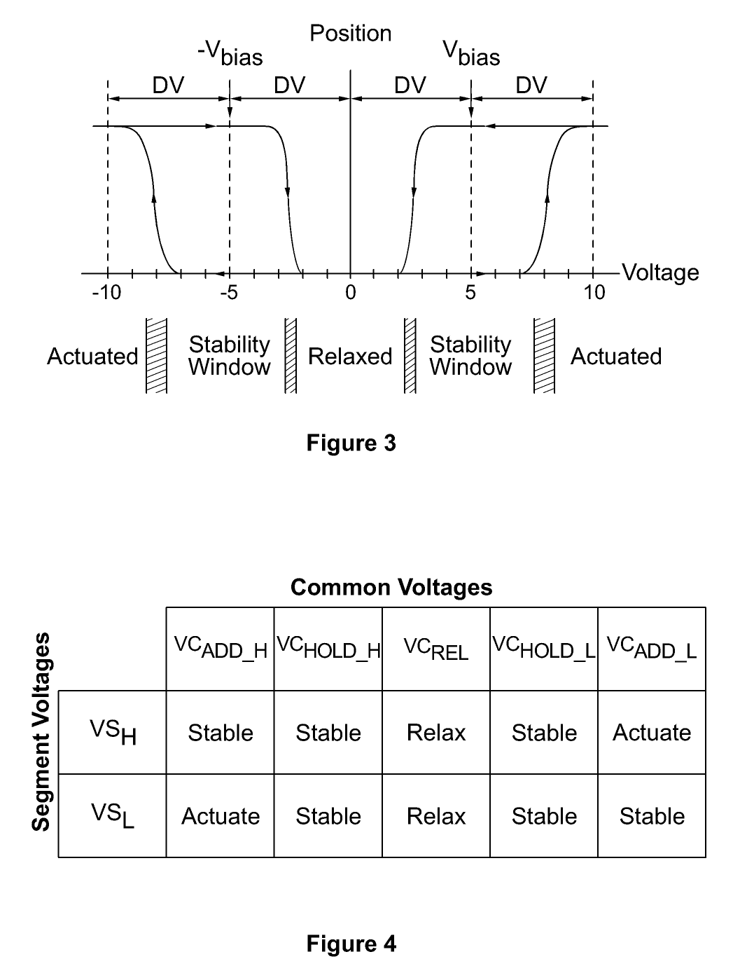

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3 to 7 volts, in this example, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about, in this example, 10 volts, and pixels that are to be relaxed are exposed to a voltage difference of near zero volts. After addressing, the pixels can be exposed to a steady state or bias voltage difference of approximately 5 volts in this example, such that they remain in the previous strobing state. In this example, after being addressed, each pixel sees a potential difference within the “stability window” of about 3-7 volts. This hysteresis property feature enables the pixel design, such as that illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

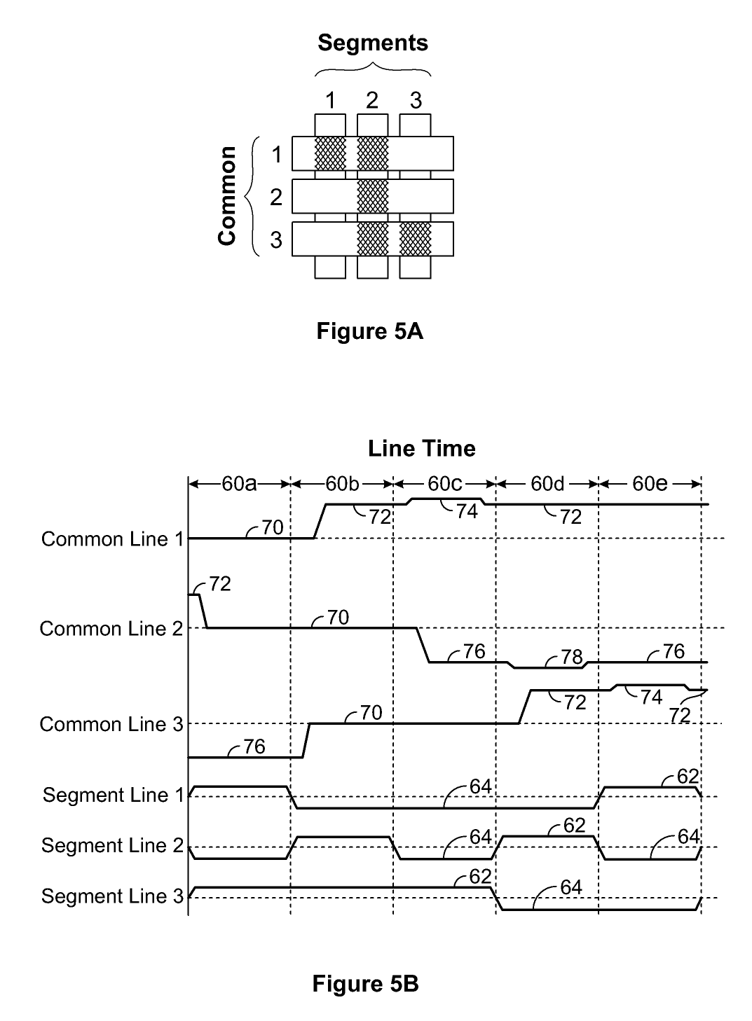

As illustrated in FIG. 4 (as well as in the timing diagram shown in FIG. 5B), when a release voltage VC_{REL} is applied along a common line, the mechanical layers of interferometric modulators along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator pixels (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, for example, a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

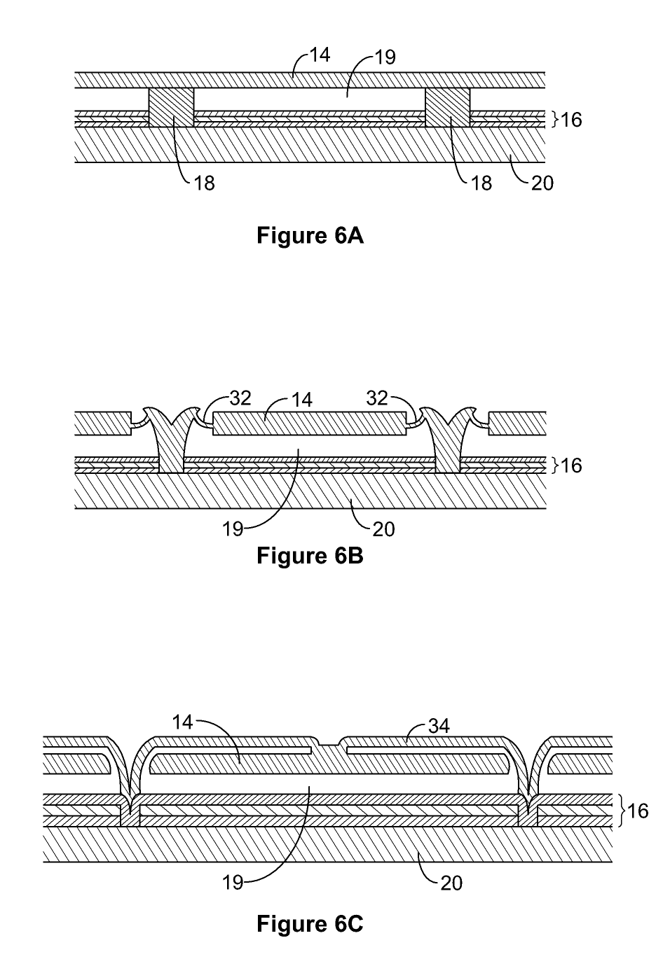

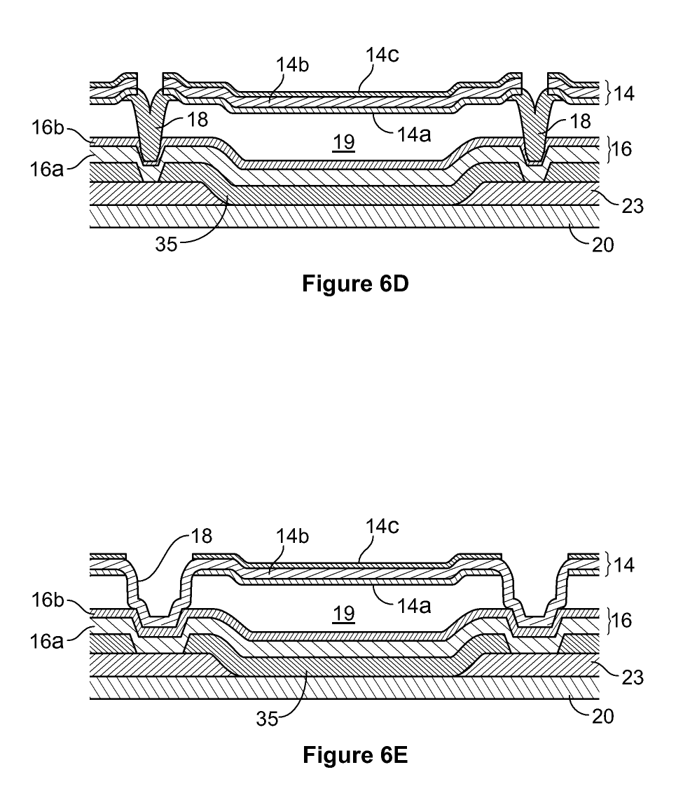

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, for example, an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (such as between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a silicon dioxide (SiO₂) layer and an aluminum alloy that serves as a reflector and a bussing layer, with a thickness in the range of about 30-80 Å, 500-1000 Å and 500-6000 Å, respectively. The one or more layers can be patterned using a variety of techniques, including photolithography and dry etching, including, for example, carbon tetrafluoromethane (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate an absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer. In some implementations, the optical absorber 16a can be an order of magnitude thinner than the movable reflective layer 14. In some implementations, the optical absorber 16a is thinner than the reflective sub-layer 14a.

In implementations such as those shown in FIGS. 6A-6E, the IMODs function as direct-view devices, in which images are viewed from the front side of the transparent substrate 20, i.e., the side opposite to that upon which the modulator is formed. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as patterning.

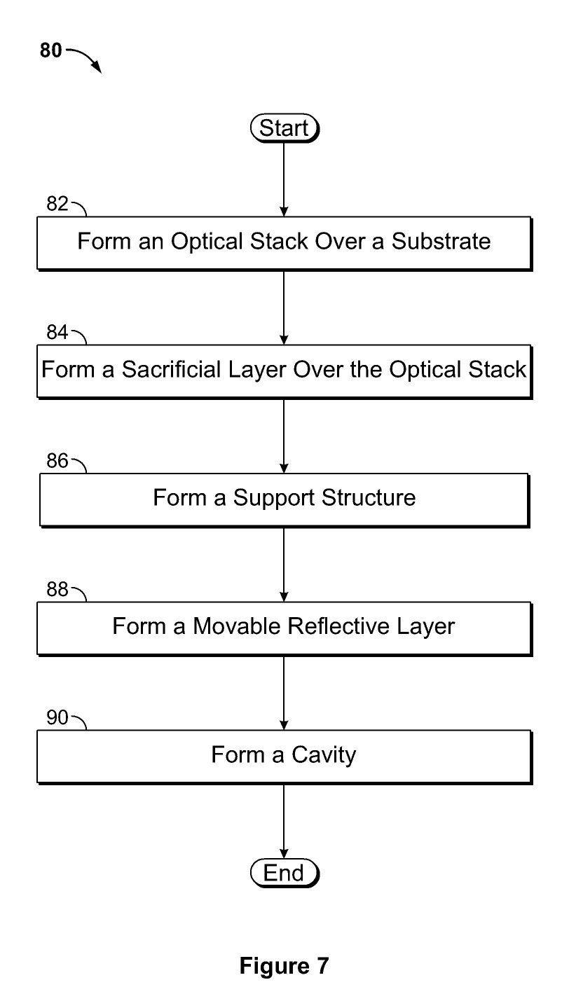

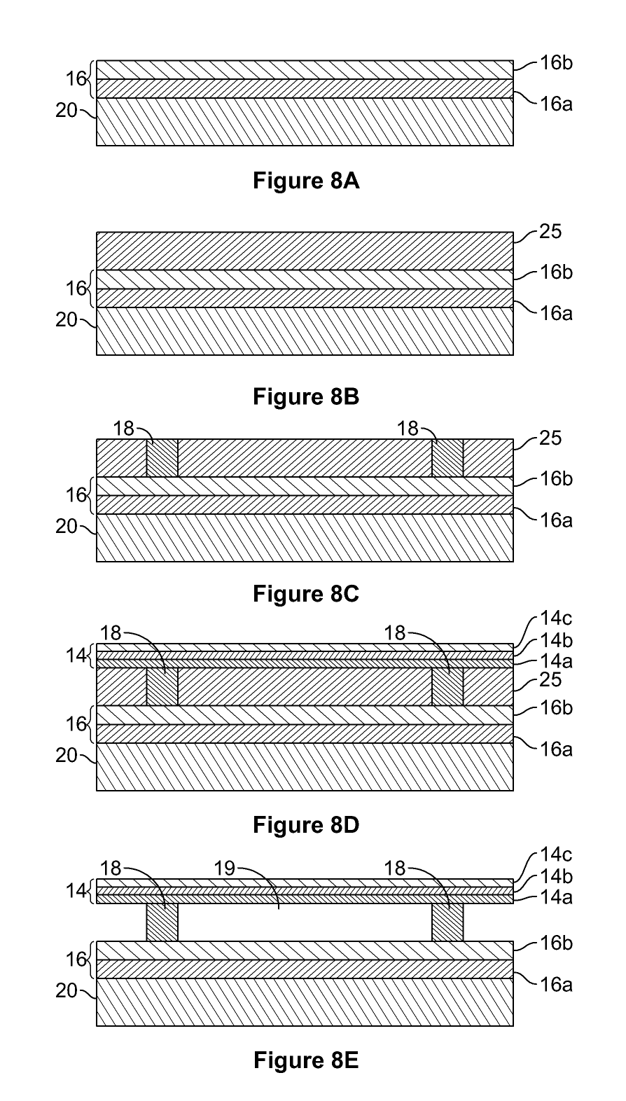

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, an electromechanical systems device such as interferometric modulators of the general type illustrated in FIGS. 1 and 6. The manufacture of an electromechanical systems device also can include other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, such as, cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In the implementation illustrated in FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and electrically conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (see block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as a post 18, illustrated in FIGS. 1, 6 and 8C. The formation of the post 18 may include patterning the sacrificial layer 25 to form a support structure aperture, then depositing a material (such as a polymer or an inorganic material, such as silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, including, for example, reflective layer (such as aluminum, aluminum alloy, or other reflective materials) deposition, along with one or more patterning, masking and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, such as cavity 19 illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, by exposing the sacrificial layer 25 to a gaseous or vaporous etchant, such as vapors derived from solid XeF₂ for a period of time that is effective to remove the desired amount of material. The sacrificial material is typically selectively removed relative to the structures surrounding the cavity 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

Electromechanical devices having a mechanical layer that curves away from a substrate are disclosed. In some implementations, the mechanical layer includes a reflective layer, a cap layer and a dielectric layer disposed between the mirror and cap layers. The mechanical layer can be deposited over a sacrificial layer to define a first height. Upon removal of the sacrificial layer, the mechanical layer can be configured to curve away from the substrate such that the mechanical layer is displaced from the substrate by a second height greater than the first height. The launch of the mechanical layer upward can be controlled by selecting certain features of the mechanical layer, including, for example, the materials, thicknesses, stresses and/or geometries of the layers of the mechanical layer.

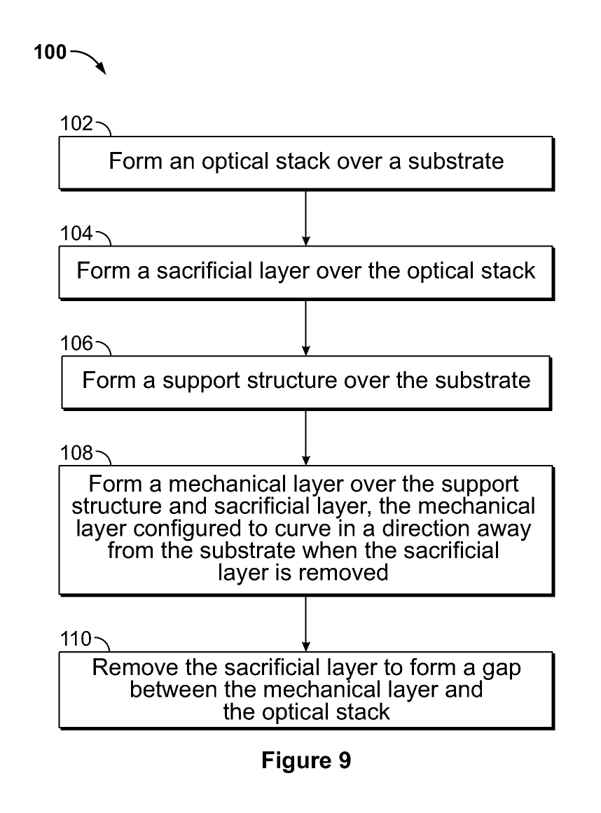

FIG. 9 shows an example of a flow diagram illustrating a manufacturing process 100 for an interferometric modulator. The process 100 illustrated in FIG. 9 starts at block 102, in which an optical stack is formed on a substrate, which also can be referred to herein as forming the optical stack “over” a substrate. The substrate can be, for example, a transparent substrate including glass or plastic. Although the process 100 is illustrated as starting at block 102, the substrate can be subjected to one or more prior preparation steps such as, for example, a cleaning step to facilitate efficient formation of the optical stack. Additionally, in some implementations, one or more layers can be provided on the substrate before forming the optical stack over the substrate. For example, a black mask can be disposed on a portion of the substrate before forming the optical stack.

As discussed above, the optical stack of an interferometric modulator can be electrically conductive, partially transparent and partially reflective, and can be fabricated, for example, by depositing one or more layers onto the substrate. In some implementations, the optical stack includes an insulating or dielectric layer covering a conductive layer which is configured to function as a stationary electrode of the interferometric modulator. The stationary electrode layer can be patterned into parallel strips to form row electrodes in a display device. As used herein, and as will be understood by a person having ordinary skill in the art, the term “patterned” is used herein to refer to masking as well as etching processes.

The process 100 illustrated in FIG. 9 continues at block 104, in which a sacrificial layer is formed over the optical stack. The formation of the sacrificial layer over the optical stack may include deposition of a fluorine-etchable material such as molybdenum (Mo) or amorphous silicon (a-Si). As will be described below with reference to block 110, the sacrificial layer is later removed to form a gap. In some implementations, multiple sacrificial layers can be deposited to achieve different gap sizes in different interferometric modulators. In some implementations, each gap size can represent a different reflected color.

The process 100 illustrated in FIG. 9 continues at block 106 with the formation of a support structure over the substrate. The support structure can include a plurality of support posts disposed around the optically active area of an interferometric modulator, for example, at the corners of a pixel of an array of interferometric modulators. Formation of the support structure may include the steps of patterning the sacrificial layer to form support structure apertures, then depositing a material (such as a silicon oxide) into the apertures using a deposition method such as plasma-enhanced chemical vapor deposition (PECVD), thermal CVD, or spin-coating. In some implementations, the support structure aperture formed in the sacrificial layer extends through both the sacrificial layer and the optical stack to an underlying structure, such as the substrate or a black mask, so that the lower end of the support post contacts the underlying layer. In some other implementations, the aperture formed in the sacrificial layer extends through the sacrificial layer, but not through the optical stack.

The process 100 continues at block 108 with the formation of a mechanical layer. The mechanical layer can be formed over the support structure and sacrificial layer, and in some implementations can include a reflective or mirror layer, a cap layer and a dielectric layer disposed between the mirror and cap layers. The mechanical layer can contact the support structure formed in block 106 over optically non-active portions of pixels of the array. The mechanical layer can be formed by employing one or more deposition steps, for example, a reflective layer (such as aluminum, or an aluminum alloy) deposition, along with one or more patterning, masking and/or etching steps. Since the sacrificial layer is still present in the partially fabricated interferometric modulator formed at block 108, the mechanical layer is typically not moveable at this stage.

The process 100 illustrated in FIG. 9 continues at block 110 with the removal of the sacrificial layer to form a cavity or gap between the mechanical layer and the optical stack. The gap may be formed by exposing the sacrificial material, such as the sacrificial material deposited at the block 104, to an etchant. For example, an etchable sacrificial material such as molybdenum (Mo), tungsten (W), tantalum (Ta), polycrystalline silicon, (poly-Si) or amorphous silicon (a-Si) may be removed by dry chemical etching, for example, by exposing the sacrificial layer to a fluorine-based gaseous or vaporous etchant, such as vapors derived from solid xenon difluoride (XeF₂). In order to etch the sacrificial material, a path can be provided for the etchant to reach the buried sacrificial materials. In some implementations, etch openings may be provided in or around the support structure to provide access to the sacrificial layer. Other etching methods, for example, wet etching and/or plasma etching, also can be used.

Before removal of the sacrificial layer, the sacrificial layer can provide a counterforce that can prevent the mechanical layer from deflecting (or moving) under the influence of forces, such as mechanical forces resulting from residual stresses in one or more sub-layers of the mechanical layer. However, upon removal of the sacrificial layer, the stress-induced forces of a mechanical layer can cause the mechanical layer to move from its previous position on the sacrificial layer.

The mechanical layer can be directed upward away from the optical stack and the substrate when the sacrificial layer is removed (in any suitable manner) and the mechanical layer is released. For example, the reflective and cap layers can be selected to be formed from a material having a tensile stress, and the thickness of the reflective layer can be selected to be greater than the thickness of the cap layer so that the reflective layer exerts a mechanical force on the mechanical layer in a direction away from the substrate.

In some implementations, the curvature of the released mechanical layer is controlled by a selected stress characteristic of the cap layer, the dielectric layer and/or the mirror layer. For example, when the cap layer and the mirror layer are formed of a material having a certain tensile stress, configuring the reflective layer to have a greater tensile stress can cause the mechanical layer to deflect upwards. The stress of the mirror layer, dielectric layer and/or cap layer can be controlled during fabrication by controlling certain processing parameters, including, for example, plasma power, pressure, process gas composition, plasma gas ratio and/or temperature. In some implementations, the stress of the reflective and/or cap layers can be changed from compressive to tensile by annealing the reflective and/or cap layers after deposition. In some implementations, the stress of a dielectric layer of the mechanical layer can be adjusted by, for example, selection of the gas composition and gas ratio when using chemical vapor deposition (CVD).

Although the process 100 is illustrated in FIG. 9 as ending at block 110, additional steps may be employed before, in the middle of, or after the illustrated sequence.

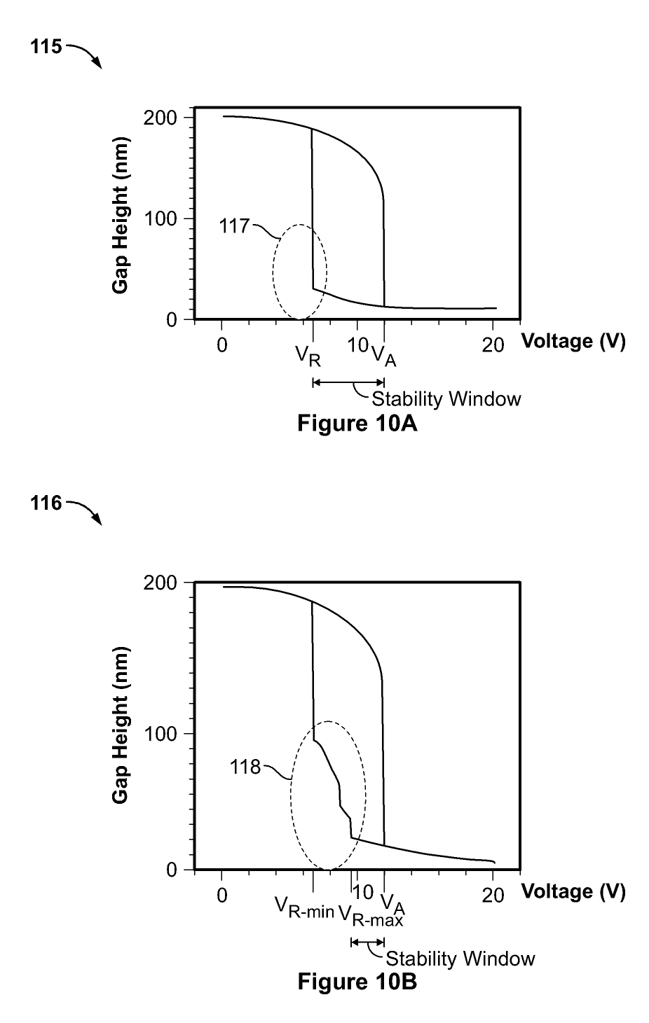

FIGS. 10A and 10B are graphs of mechanical layer position versus voltage for two examples of interferometric modulator devices.

FIG. 10A illustrates an example of a graph 115 of gap height (the distance between the mechanical layer position and the optical stack) as a function of a voltage differential between the mechanical layer and a stationary electrode for one example of an interferometric modulator device. The graph 115 shows that when the voltage of the mechanical layer and the stationary electrode is about the same, i.e., the voltage difference is equal to about 0 V, the mechanical layer can be in a relaxed unactuated position and have a relatively large gap height. As the voltage difference between the mechanical layer and the stationary electrode increases, electrostatic forces pull the mechanical layer toward the stationary electrode. When an actuation voltage V_{A} is reached, the electrostatic forces generated by the applied voltage can collapse (or actuate) the mechanical layer, and the mechanical layer can have a gap height of about 0 nm.

The mechanical layer can remain in the collapsed position as long as the voltage between the mechanical layer and the stationary electrode is greater than about a release voltage V_{R}. However, when the voltage falls below the release voltage V_{R}, mechanical forces, such as elastic spring forces of the mechanical layer, can become greater than electrostatic forces associated with the applied voltage. Accordingly, the mechanical layer can release and enter the relaxed state when the voltage difference between the mechanical layer and the stationary electrode becomes less than about the release voltage V_{R}. As shown in the region 117 of the graph 115, the mechanical layer can have a relatively sharp transition between the actuated and unactuated positions.

The graph 115 exhibits a hysteresis effect, in which the mechanical layer is stable in both of the relaxed or actuated states when biased within a stability window defined by a range of voltages between the release voltage V_{R} and the actuation voltage V_{A}. The hysteresis of the mechanical layer can be utilized when addressing an array of interferometric modulator devices, as was described earlier with respect to FIG. 3. It can be useful to configure interferometric modulators to have a relatively wide stability window that has a relatively small pixel-to-pixel variation. Wide stability windows can aid in improving panel margin, or the window of bias voltages that can be used to retain the mechanical layer in its current state.

FIG. 10B illustrates an example of a graph 116 of gap height (mechanical layer position) as a function of a voltage differential between a stationary electrode and the mechanical layer for another example of an interferometric modulator device. The illustrated graph 116 is similar to the graph 115 of FIG. 10A, except that the device of FIG. 10B does not sharply transition between the actuated and relaxed (unactuated) positions. Rather, as shown by the region 118 of the graph 116, the device of FIG. 10B does not smoothly transition between the actuated and relaxed states. In some configurations, when switching an interferometric modulator device between actuated and relaxed positions, the edges of the mechanical layer can release at a different voltage than the center of the mechanical layer. For example, the edges of the mechanical layer can begin to release when the voltage falls below about a maximum release voltage V_{R-max}, but the mechanical layer may not fully release until the voltage falls below about a minimum release voltage V_{R-min}. This phenomenon may be referred to as “soft-release”, and can lead to non-ideal switching performance and a reduction in the stability window and a reduction in panel margin of the device with the characteristics illustrated in the graph 116 compared to the device with the characteristics illustrated in the graph 115. When biasing an array of interferometric modulator devices suffering from soft release, the bias voltage may not be large enough for the edges of certain actuated pixels to stay at the actuated dark state, which can lead to the generation of colored rings for certain pixels which are, or should be, in a dark (off, actuated) state.

For improved optical performance, it has been found that a released mechanical layer in the relaxed position should have an upward curvature (that is a curved shape where the center of the mechanical layer in the optically active region is farther away from the optical stack than edge portions of the mechanical layer in the optically active region). In other words, the launch of the mechanical layer has been found to reduce the incidence of soft release when compared to a “flat” mechanical layer with little or no launch. Accordingly, some implementations described herein seek to configure (or shape) the mechanical layer after removal of the sacrificial layer (“release”) such that the curvature of the mechanical layer is upward or away from the substrate. For example, it has been found that for some implementations a mechanical layer that has a maximum displacement from the optical stack that is about 10 nm to about 30 nm greater than an average displacement of the mechanical layer from the optical stack can provide improved performance relative to a mechanical layer that is flat or curves downward upon release. As used herein, the term “average displacement” of the mechanical layer refers to the mean distance between the mechanical layer and the optical stack over the optically active area of a pixel after the mechanical layer has been released and is in the relaxed position. In some implementations, the device is configured so that a difference between the smallest gap height and the largest gap height of the mechanical layer over an optically active region of the device when the mechanical layer is in a relaxed (or unactuated) state is in the range of about 30 nm to about 100 nm. Such implementations of the mechanical layer can be accomplished by consideration and selection of certain materials, stress characteristics, structural thickness of layers of the mechanical layer, and/or fabrication processes.

Electromechanical devices having a mechanical layer with upward curvature can have a greater contact area with the optical stack in the actuated position relative to other devices that do not have an upward curvature. For mechanical layers having an upward curvature, a relatively smaller portion of the mechanical layer disposed adjacent to the support posts on the edges on an optically active area of the device can be out of contact with the optical stack during actuation. Thus, electromechanical devices having upwardly curved mechanical layers can have improved dark state. Additionally, mechanical layers that bend away from the substrate can be switched between actuated and relaxed positions using a relatively smaller release voltage, which can lead to a reduction in dynamic power consumption in a pixel array employing such devices. Furthermore, electromechanical devices having upwardly curved mechanical layers can have an improved panel margin.

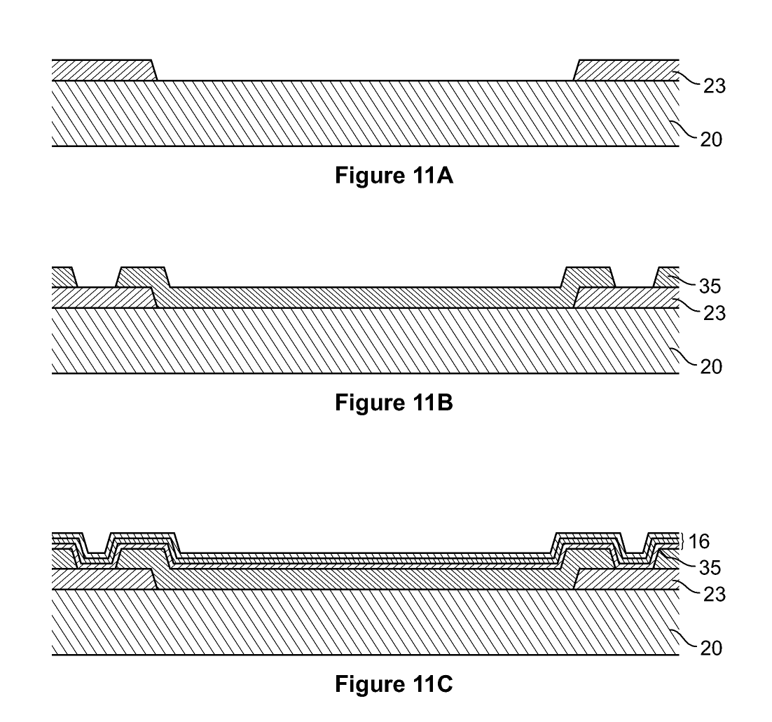

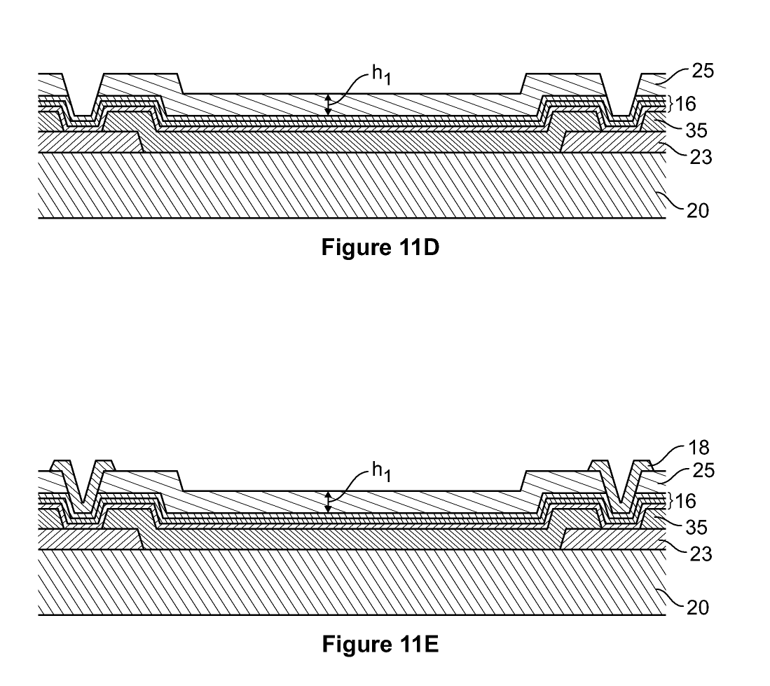

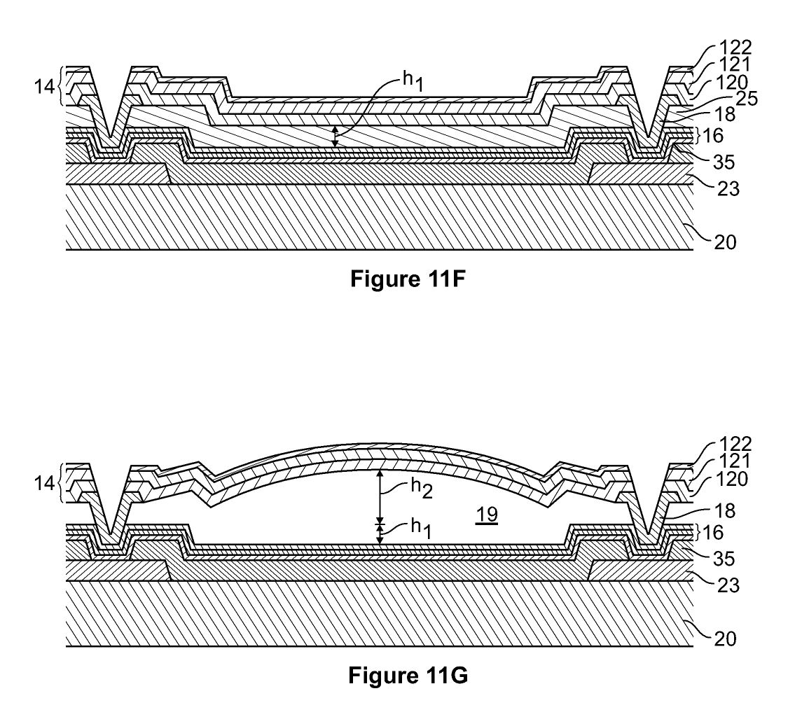

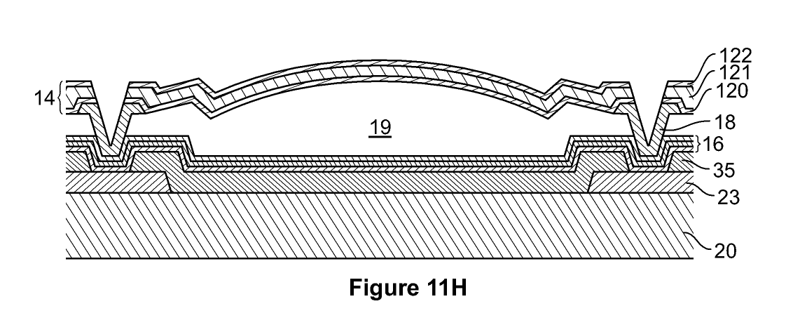

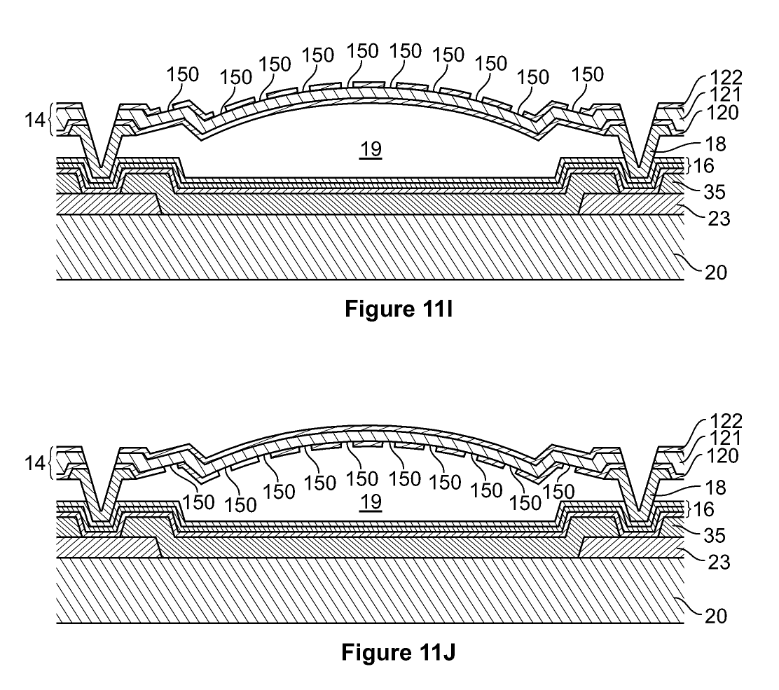

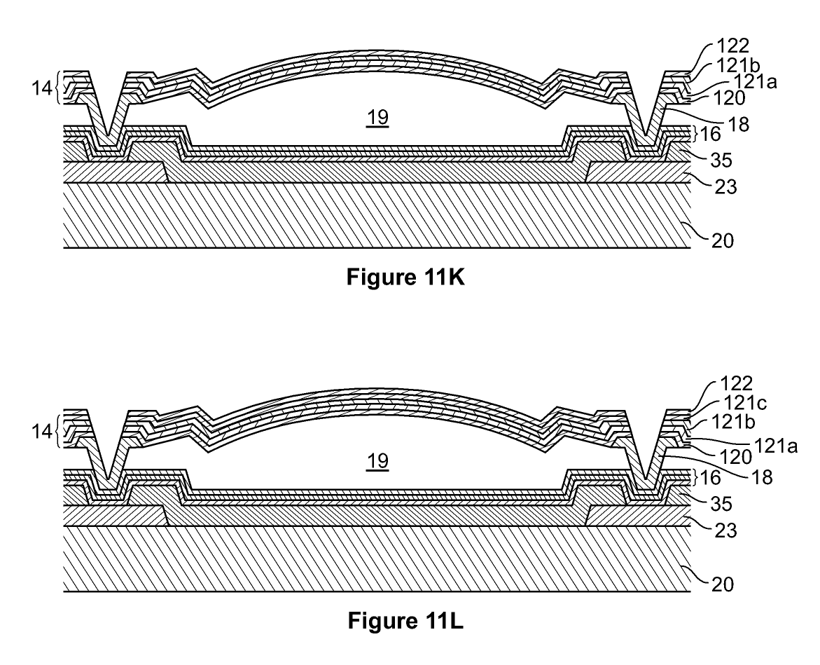

FIGS. 11A-11L show examples of cross-sectional schematic illustrations of various stages in methods of making interferometric modulators, according to various implementations. While particular parts and steps are described as suitable for interferometric modulator implementations, a person having ordinary skill in the art will readily understand that for other electromechanical systems or microelectromechanical systems implementations, different materials can be used or parts modified, omitted, or added.

In FIG. 11A, a black mask structure 23 has been provided and patterned on a substrate 20. The substrate 20 can include a variety of materials, including glass, plastic or any transparent polymeric material which permits images to be viewed through the substrate 20. The black mask structure 23 can be configured to absorb ambient or stray light in optically inactive regions (for example, beneath supports or between pixels) to improve the optical properties of a display device by increasing the contrast ratio. Additionally, the black mask structure 23 can be conductive and configured to function as an electrical bussing layer.

The black mask structure 23 can be formed using a variety of methods, including deposition and patterning techniques as described above with reference to FIG. 9. The black mask structure 23 can include one or more layers which can be patterned using a variety of techniques, including photolithography and etch.

Although FIGS. 11A-11L are shown as including the black mask structure 23, the methods of directing the curvature of a mechanical layer upward as described herein can be equally applicable to processes that do not include forming the black mask structure 23.

FIG. 11B illustrates providing and patterning a spacer or dielectric structure 35. The dielectric structure 35 can include, for example, silicon oxynitride (SiON) and/or another dielectric material such as a silicon nitride or silicon oxide. In some implementations, the thickness of the dielectric structure 35 is in the range of about 3,000-5,000 Å. However, the dielectric structure 35 can have a variety of thicknesses depending on the desired optical properties. As illustrated in FIG. 11B, the dielectric structure 35 can be removed over a portion above the black mask structure 23. Removing a portion of the dielectric structure 35 in this manner permits routing and row electrode layers to reach the black mask structure 23, such as in implementations in which the black mask structure 23 serves to bus signals. However, in some implementations, a portion of the dielectric structure 35 need not be removed above the black mask structure 23.

FIG. 11C illustrates providing an optical stack 16 over the dielectric structure 35. As described above in relation to FIG. 1, the optical stack 16 can include several layers, including, for example, a stationary electrode or transparent conductor layer, such as indium tin oxide (ITO), a partially reflective optical absorber layer, such as chromium (Cr), and a transparent dielectric. As illustrated in FIG. 11C, one or more layers of the optical stack 16 may physically and electrically contact the black mask structure 23.

FIG. 11D illustrates providing and patterning a sacrificial layer 25 over the optical stack 16. The sacrificial layer 25 is typically later removed to form a gap. The formation of the sacrificial layer 25 over the optical stack 16 can include a deposition step, as described above with reference to FIG. 9. Additionally, the sacrificial layer 25 can be selected to include more than one layer, or include a layer of varying thickness, to aid in the formation of a display device having a multitude of resonant optical gaps among different sub-pixels of the array. For an interferometric modulator array, each gap size can represent a different reflected color. Moreover, in some implementations, multiple layers of different functions can be provided, over or between sacrificial layers. As illustrated in FIG. 11D, the sacrificial layer 25 may be patterned over the black mask structure 23 to form apertures that can be used to form support posts.

As will be described later below, a mechanical layer can be subsequently deposited over the sacrificial layer 25, and thereafter the sacrificial layer 25 can be removed. When the sacrificial layer 25 is removed, the mechanical layer can be configured to move, or “launch” upwards. Thus, the thickness h₁ of the sacrificial layer 25 can be less than the gap height of the mechanical layer in the relaxed position. In some implementations, the sacrificial layer 25 can has a thickness h₁ in the range of about 10 nm to about 450 nm. For example, for red, green and blue interferometric modulator implementations, the height h₁ can be in the range of about 50-350 nm, about 10-250 nm and about 50-450 nm, respectively.

FIG. 11E illustrates providing and patterning a support layer to from support posts 18. The support posts 18 can be used to support a subsequently deposited mechanical layer, as will be described below. In some implementations (not illustrated), the mechanical layer 14 is a self-supporting mechanical layer, in which case the support posts 18 are not deposited prior to deposition of the mechanical layer 14. The support posts 18 can include, for example, silicon dioxide (SiO₂) and/or silicon oxynitride (SiON). The support layer can be patterned to form the support posts 18 by any suitable technique, such as using a dry etch including carbon tetrafluoromethane (CF₄).

Reference will now be made to FIGS. 11F and 11G. FIG. 11F illustrates providing and patterning a mechanical layer 14 over the sacrificial layer 25 and the support posts 18. As illustrated, the mechanical layer 14 includes three sub-layers. Providing and patterning the mechanical layer 14 may include depositing a first layer (such as a mirror layer 120), depositing a second layer (such as a dielectric layer 121) and depositing a third layer (such as a cap layer 122). Each layer 120, 121 and 122 may be patterned separately, or together. Some layers may be patterned differently from each other. In implementations where the mechanical layer 14 is self supporting, some of the layers may remain patterned to be cut at the ends of the pixel as shown, while at least one layer, for example dielectric layer 121, may curve down to contact the optical stack 16 or the black mask structure 23 to provide support for the mechanical layer 14. FIG. 11G illustrates the interferometric device after removal of the sacrificial layer 25 of FIG. 11F to form a gap 19. The gap 19 is illustrated as larger than the height of the sacrificial layer 25 that was removed.

The mechanical layer 14 includes a mirror layer 120 disposed over the sacrificial layer 25, a dielectric layer 121 disposed over the mirror layer 120 and a cap layer 122 disposed over the dielectric layer 121. The mirror layer 120 can be formed from any suitable reflective material, including, for example, a metal, such as an aluminum alloy. The dielectric layer 121 can be a dielectric layer of, for example, silicon oxynitride (SiON) or silicon dioxide (SiO₂). The thickness of the dielectric layer 121 can be determined based on a variety of factors, including, for example, the desired stiffness of the mechanical layer 14. The cap layer 122 can include a metallic material, and can be selected to be formed of a material that has substantially the same composition as the mirror layer 120. In one implementation, the mirror and cap layers 120, 122 each include aluminum-copper (AlCu) having copper by weight in the range of about 0.3% to 1.0%, for example, about 0.5%.

As illustrated in FIG. 11G, the sacrificial layer 25 may be removed after formation of the mechanical layer 14. The sacrificial layer 25 can be removed using a variety of techniques, as was described earlier with respect to FIG. 9. After removal of the sacrificial layer 25, the mechanical layer 14 can become displaced away from the substrate 20 by a launch height h₂ and can change its curvature. In some implementations, the launch height h₂ is selected to be in the range of about 50 nm to about 200 nm, so that the resulting curvature defined as the distance from the top of the mechanical layer to the average mechanical layer position is about 10 nm to 30 nm. As used herein, the term “average displacement” of the mechanical layer 14 refers to the mean distance between the mechanical layer 14 and the optical stack 16 over the optically active area of a pixel after the mechanical layer 14 has been released and is in the relaxed position.

In some implementations, the launch of the mechanical layer 14 can be controlled by selecting the thickness of the mirror layer 120 to have a thickness greater than the cap layer 122. Because the mirror layer 120 and the cap layer 122 can each have tensile stresses that act to pull inwardly on the mechanical layer 14, forming the mirror layer 120 to have a thickness greater than that of the cap layer 122 can aid in generating a net force on the mechanical layer 14 that can direct the mechanical layer 14 away from the optical stack 16 upon removal of the sacrificial layer 25. For example, the mirror and cap layers 120, 122 can be configured to have a compressive stress, and the relative thicknesses of the mirror and cap layers 120, 122 can be selected to tune the launch of the mechanical layer 14, thereby increasing the launch and curvature of the mechanical layer 14 to a desired degree. For instance, the thicknesses of the mirror and cap layers 120, 122 can affect the net internal stress of the mechanical layer 14. Upon removal of the sacrificial layer 25, the internal stresses can exert a force on the mechanical layer 14, thereby deflecting the mechanical layer 14 upwards.

In some implementations, the mirror layer 120 has a thickness in the range of about 250-650 Å, for example, about 430 Å, the cap layer 122 has a thickness in the range of about 200-600 Å, for example, about 370 Å, and the thickness of the mirror layer 120 is selected to be about 50 to 150 Å greater than a thickness of the cap layer 122. However, the mirror layer 120 and the cap layer 122 can have any suitable thickness, and the mirror layer 120 can have a thickness sized relative to a thickness of the cap layer 122. For example, the mirror layer 120 can have a thickness that is greater than a thickness of the cap layer 122 by a factor ranging between about 1.0 to about 1.2.

In some implementations, mirror layer 120 and the cap layer 122 include the same material. For example, the mirror and cap layers 120, 122 can each include aluminum copper (AlCu). Selecting the same material for the mirror and cap layers 120, 122 can result in the mechanical layer 14 having balanced forces when the mirror and cap layers 120, 122 are of substantially equal thicknesses and otherwise fabricated in a similar manner. By configuring the mirror and cap layers 120, 122 in this way, a thickness of the mirror layer 120 can be changed relative to that of the cap layer 122 to provide relatively fine-tuned control over mechanical layer launch. Thus, employing a symmetric structure allows a relative difference between the mirror and cap layers 120, 122 to be used to tune launch to have a desired displacement of the mechanical layer, thereby avoiding a need to fabricate a single layer with an absolute stress of a particular value, which may be difficult to accomplish from device-to-device due to process variation.

FIG. 11H illustrates an interferometric device according to another implementation. The interferometric device of FIG. 11H is similar to the interferometric device of FIG. 11G, except the interferometric device of FIG. 11G includes a mechanical layer 14 in which the mirror layer 120 and the cap layer 122 are of an equal thickness. In some implementations, the mechanical layer 14 can be configured to curve upwards by controlling parameters besides a thickness of the mirror and cap layers 120, 122.

In some implementations, the mechanical layer 14 is configured to have a certain stress, which can be used to control the gap between the mechanical layer 14 and the optical stack 16 after release of the mechanical layer 14. For example, the mechanical layer 14 can be configured to have a net stress in the range of about +100 MPa to about +300 MPa, for example, about +200 MPa, so that the mechanical force associated with the stress directs the mechanical layer to move, or be displaced, away from the substrate (“upwards”). In some implementations, the curvature of the mechanical layer is controlled by a selected stress characteristic of the cap layer 122 relative to a stress characteristic of the mirror layer 120. For example, when the cap layer 122 and the mirror layer 120 are formed of a material having a tensile stress, selecting the mirror layer 120 to have a greater tensile stress than the cap layer 122 can cause the mechanical layer 14 to deflect upwards. When the cap layer 122 and mirror layer 120 are formed of a material having compressive stress, configuring the cap layer 122 to have a greater compressive stress than the mirror layer 120 can cause the mechanical layer 14 to deflect upwards. The stress of the mirror layer 120 and the cap layer 122 can be controlled in any suitable manner, for example, by controlling certain processing parameters, including, for example, plasma power, pressure, process gas composition, plasma gas ratio and/or temperature.

In some implementations, the stress of the mirror layer 120 is selected to be in the range of about +100 MPa to about +400 MPa, for example, about +300 MPa, and the stress of the cap layer 122 is selected to be in the range of about +100 MPa to about +400 MPa, for example, about +200 MPa. In some other implementations, the stress of the mirror layer 120 is selected to be in the range of about −100 MPa to about −400 MPa, for example, about −200 MPa, and the stress of the cap layer 122 is selected to be in the range of about −100 MPa to about −400 MPa, for example, about −300 MPa. Persons having ordinary skill in the art will appreciate that positive stresses can be associated with tensile stresses and negative stresses can be associated with compressive stresses.

FIG. 11I illustrates an interferometric device according to another implementation. The interferometric device of FIG. 11I is similar to the interferometric device of FIG. 11G. However, in contrast to the interferometric device of FIG. 11G, the interferometric device of FIG. 11I includes a cap layer 122 having cuts or patterns 150. In some implementations, the mechanical layer 14 can be configured to curve upwards by including patterning on one or more layers of the mechanical layer 14. For example, the cap layer 122 can have a tensile stress and can include the cuts 150 to reduce the tensile stress of the cap layer 122 so as to control the net stress of the mechanical layer 14. In some implementations, the cuts 150 have a number and size selected to obtain a desired net stress of the mechanical layer 14 corresponding to a desired upward displacement of the mechanical layer 14 after removal of a sacrificial layer.

The cuts 150 can have any suitable pattern selected to achieve the desired stress of the mechanical layer 14, including, for example, uniform or non-uniform patterns. In some implementations, the cuts 150 have a radial symmetry relative to a pixel center when the cuts 150 are viewed from above the substrate 20. The cuts 150 can be spaced apart from one another to achieve a desired net stress of the mechanical layer 14. For example, increasing the number and/or size of the cuts 150 can reduce the stress of the cap layer 122 by reducing tension in the mechanical layer 14. The cuts 150 can be formed using any suitable process, including, for example, a photolithography and etch process. In some implementations, the cuts 150 are located near pixel edges. For example, the mechanical layer 14 can have a relatively high stress near the posts 18, and thus providing the cuts 150 near the posts 18 can have a relatively large impact on the launch of the mechanical layer 14 after removal of the sacrificial layer.

FIG. 11J illustrates an interferometric device according to another implementation. The interferometric device of FIG. 11J is similar to the interferometric device of FIG. 11I. However, in contrast to the interferometric device of FIG. 11I, the interferometric device of FIG. 11J includes a mirror layer 120 having cuts or patterns 150. In some implementations, the mechanical layer 14 can be configured to curve upwards by including patterning on the mirror layer 120. For example, in some implementations the mirror layer 120 can have a compressive stress and the cuts 150 can be included to reduce the compressive stress of the mirror layer 120 so as to cause the mechanical layer 14 to have an upward displacement after removal of a sacrificial layer. The cuts 150 can have any suitable pattern, including, for example, uniform or non-uniform patterns. Additional details of the cuts 150 can be as described above with respect to FIG. 11I.

FIG. 11K illustrates an interferometric device according to another implementation. The interferometric device of FIG. 11K is similar to the interferometric device of FIG. 11H. However, in contrast to the interferometric device of FIG. 11H, the mechanical layer 14 of the interferometric device of FIG. 11K includes a mirror layer 120, a first dielectric sub-layer 121a, a second dielectric sub-layer 121b, and a cap layer 122.

The first and second dielectric sub-layers 121a, 121b can be used to create a stress gradient in the mechanical layer 14 that can be used to control the curvature of the mechanical layer 14 when the sacrificial layer is removed. For example, the first dielectric sub-layer 121a can be configured to have a stress that is greater than a stress of the second dielectric sub-layer 121b such that the mechanical layer 14 has a positive stress gradient directed toward the substrate 20. Since the edges of the mechanical layer 14 can curve in the direction of the positive stress gradient when the sacrificial layer is removed, forming the first dielectric sub-layer 121a with a stress that is greater than the second dielectric sub-layer 121b can cause the mechanical layer 14 to launch upward upon release.

In some implementations, the first and second dielectric sub-layers 121a, 121b are formed from substantially the same material, such as silicon oxynitride (SiON), silicon dioxide (SiO₂), aluminum nitride (AlN) or aluminum oxynitride (AlON), but the first dielectric sub-layer 121a is configured to have a stress that is greater than the stress of the second dielectric sub-layer 121b. For example, the first dielectric sub-layer 121a can have a stress that is about +10 MPa to about +200 MPa greater than a stress of the second dielectric sub-layer 121b. For example, in some implementations, the first dielectric sub-layer 121a has a stress in the range of about 100 MPa to about 500 MPa, for example, about 250 MPa, and the second dielectric sub-layer 121b has a stress in the range of about 20 MPa to about 100 MPa, for example, about 60 MPa.

The stress of the first and second dielectric sub-layers 121a, 121b can be controlled using any suitable technique. For example, the stress of the first and second dielectric sub-layers 121a, 121b can be controlled by selection of the gas composition, gas ratio used, deposition power, deposition pressure, and combinations of these parameters when depositing the dielectric sub-layers. The first and second dielectric sub-layers 121a, 121b can have the same or different thicknesses. For example, in some implementations the first dielectric sub-layer 121a can have a thickness in the range of about 200-5,000 Å, for example, about 1,300 Å, and the second dielectric sub-layer 121b can have a thickness in the range of about 200-5,000 Å, for example, about 1,000 Å.

FIG. 11L illustrates an interferometric device according to another implementation. The interferometric device of FIG. 11L is similar to the interferometric device of FIG. 11K, except that the mechanical layer 14 of the interferometric device of FIG. 11L includes a mirror layer 120, a first dielectric sub-layer 121a, a second dielectric sub-layer 121b, a third dielectric sub-layer 121c, and a cap layer 122.

In some implementations, the mechanical layer 14 can include more than two dielectric sub-layers having stresses selected to control the launch of the mechanical layer 14. For example, the first dielectric sub-layer 121a can be configured to have a stress that is greater than a stress of the second dielectric sub-layer 121b, and the second dielectric sub-layer 121b can be configured to have a stress that is greater than a stress of the third dielectric sub-layer 121c. By forming the first to third dielectric sub-layers 121a-121c in this manner, the mechanical layer 14 can be formed to have a positive stress gradient directed toward the substrate 20 that can direct the curvature of the mechanical layer 14 upward when the sacrificial layer is removed.

For example, in some implementations, the first to third dielectric sub-layers 121a-121c are formed from substantially the same material, and the first dielectric sub-layer 121a has a stress in the range of about 200 MPa to about 300 MPa, for example, about 250 MPa, the second dielectric sub-layer 121b has a stress in the range of about 150 MPa to about 250 MPa, for example, about 200 MPa, and the third dielectric sub-layer 121c has a stress in the range of about 100 MPa to about 200 MPa, for example, about 150 MPa. The stress of the first to third dielectric sub-layers 121a-121c can be controlled by, for example, selecting processing parameters during deposition of the dielectric sub-layers. For example, in some implementations the first dielectric sub-layer 121a has a thickness in the range of about 200-5,000 Å, for example, about 1,300 Å, the second dielectric sub-layer 121b has a thickness in the range of about 200-5,000 Å, for example, about 1,000 Å, and the third dielectric sub-layer 121c has a thickness in the range of about 200-5,000 Å, for example, about 1,000 Å. Although FIG. 11L illustrates a configuration in which three dielectric sub-layers 121a-121c are used, addition dielectric sub-layers can be included to further control the stress gradient and launch of the mechanical layer 14. Furthermore, while the discussion above regarding FIGS. 11K and 11L focused primarily on controlling a stress gradient of dielectric sub-layers, it is understood that a stress gradient in the mechanical layer 14 also may be achieved by creating a stress gradient between the mirror layer 120 and one or more of the dielectric sub-layers 121a-121c and/or by creating a stress gradient between one or more of the dielectric sub-layers 121a-121c and the cap layer 122. In some implementations, the launch of the mechanical layer 14 is controlled by creating a stress gradient among any two or more of the mirror layer 120, the dielectric sub-layers 121a-121c, and the cap layer 122. In various implementations, the stress gradient is created by having step differences in stress between all of the sub-layers including the mirror layer 120, the dielectric sub-layers 121a-121c, and the cap layer 122.

Although FIGS. 11K and 11L illustrate configurations in which the mechanical layer 14 includes two dielectric sub-layers and three dielectric sub-layers, respectively, in some implementations the mechanical layer 14 can include additional dielectric sub-layers. For example, in some implementations, the mechanical layer 14 can include four or more dielectric sub-layers to provide additional control over the stress gradient.

The launch of the mechanical layer away from the substrate can be controlled by using more than one parameter or technique. For example, one or more of the thickness, stress, patterning, composition and/or geometry of one or more sub-layers of the mechanical layer can be configured to direct the launch of the mechanical layer to a desired value. Accordingly, in some implementations, the launch of the mechanical layer 14 is controlled by selection of a thickness of the cap layer 120 relative to a thickness of the mirror layer 122 and/or by controlling a stress gradient of the mechanical layer 120 by depositing a plurality of sub-layers (dielectric and/or metal) with different stresses. Furthermore, in some implementations, the launch of the mechanical layer 14 is controlled by patterning the mirror and/or cap layer to include the cuts 150 and/or by controlling a stress gradient of the mechanical layer 120 by depositing a plurality of sub-layers (dielectric and/or metal) with different stresses. Thus, in some implementations a plurality of launch control techniques can be combined to achieve the desired launch characteristic of the mechanical layer 14.

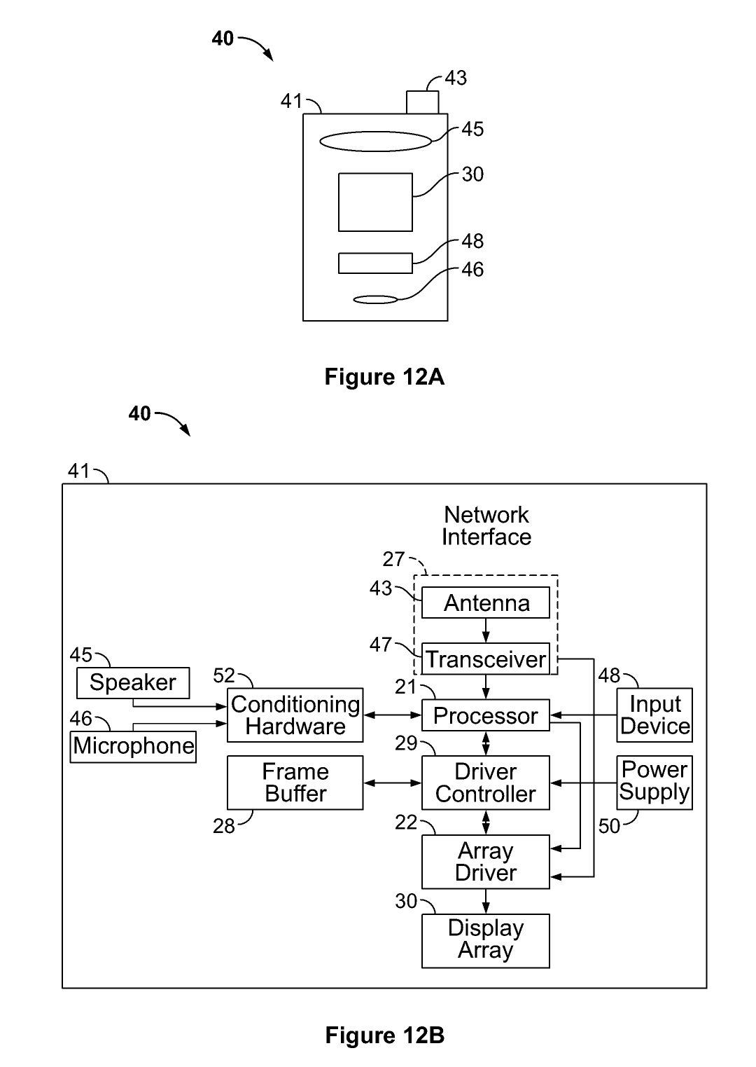

FIGS. 12A and 12B show examples of system block diagrams illustrating a display device 40 that includes a plurality of interferometric modulators. The display device 40 can be, for example, a smart phone, a cellular or mobile telephone. However, the same components of the display device 40 or slight variations thereof are also illustrative of various types of display devices such as televisions, tablets, e-readers, hand-held devices and portable media players.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 12B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (such as an IMOD controller). Additionally, the array driver 22 can be a conventional driver or a bi-stable display driver (such as an IMOD display driver). Moreover, the display array 30 can be a conventional display array or a bi-stable display array (such as a display including an array of IMODs). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blue-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other possibilities or implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of an IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. An electromechanical systems device, comprising:
a substrate; and
a movable layer positioned over the substrate, the movable layer spaced from the substrate and defining one side of a gap between the movable layer and the substrate, wherein the movable layer is movable in the gap between an actuated position and a relaxed position,
wherein the movable layer includes a mirror layer, a cap layer, and a dielectric layer disposed between the mirror layer and the cap layer, the mirror layer facing the gap, and
wherein the movable layer is configured to have a curvature in a direction away from the substrate when the movable layer is in the relaxed position.

2. The device of claim 1, wherein the mirror and cap layers each have a tensile stress, the tensile stress of the mirror layer being greater than the tensile stress of the cap layer.

3. The device of claim 1, wherein a thickness dimension of the mirror layer is greater than a thickness dimension of the cap layer.

4. The device of claim 3, wherein the mirror layer thickness dimension is greater than the cap layer thickness dimension by a factor ranging between about 1.0 to about 1.2.

5. The device of claim 3, wherein the mirror layer thickness dimension is greater than the cap layer thickness dimension by about 50 Å to about 100 Å.

6. The device of claim 3, wherein the mirror layer thickness dimension is between about 250 Å and about 650 Å, and the cap layer thickness dimension is between about 200 Å and about 600 Å.

7. The device of claim 1, wherein the movable layer is configured such that a portion of the movable layer above a center of a pixel of the device is displaced from the substrate by about 10 nm to about 30 nm more than an average distance between the movable layer and the substrate over an optically active area of the pixel when the movable layer is in the relaxed position.

8. The device of claim 1, wherein the mirror layer and the cap layer are formed from substantially the same material.

9. The device of claim 1, wherein at least one of the reflective layer and cap layer include aluminum-copper (AlCu).

10. The device of claim 1, wherein the dielectric layer includes at least one of silicon oxynitride (SiON) and silicon dioxide (SiO₂).

11. The device of claim 1, wherein the cap layer has a tensile stress and includes cuts for reducing the tensile stress of the cap layer such that the movable layer curves in a direction away from the substrate.

12. The device of claim 1, wherein the mirror layer has a compressive stress and includes cuts for reducing a magnitude of the compressive stress of the mirror layer such that the movable layer curves in a direction away from the substrate.

13. The device of claim 1, wherein a difference between a smallest gap height and a largest gap height of the movable layer over an optically active region of the device is in the range of about 30 nm to about 100 nm.

14. The device of claim 1, further comprising a stationary electrode positioned between the substrate and the gap.

15. The device of claim 14, further comprising a bias circuit configured to apply a bias voltage across the stationary electrode and the movable layer.

16. The device of claim 1, wherein the mirror and cap layers each have a compressive stress, a magnitude of the compressive stress of the mirror layer less than a magnitude of the compressive stress of the cap layer.

17. The device of claim 1, wherein the dielectric layer includes a first dielectric sub-layer and a second dielectric sub-layer disposed over the first dielectric sub-layer, wherein the first dielectric sub-layer has a stress that is greater than a stress of the second dielectric sub-layer such that the movable layer has a stress gradient that increases toward the substrate.

18. The device of claim 17, wherein the first dielectric sub-layer has a stress that is about +10 MPa to about +200 MPa greater than a stress of the second dielectric sub-layer.

19. The device of claim 17, wherein a thickness of the first dielectric sub-layer is in the range of about 200 Å to about 5,000 Å, and wherein a thickness of the second dielectric sub-layer is in the range of about 200 Å to about 5,000 Å.

20. The device of claim 1, further comprising:
a display including one or more of the electromechanical systems devices;
a processor that is configured to communicate with the display, the processor being configured to process image data; and
a memory device that is configured to communicate with the processor.

21. The device of claim 20, further comprising:
a driver circuit configured to send at least one signal to the display; and
a controller configured to send at least a portion of the image data to the driver circuit.

22. The device of claim 20, further comprising an image source module configured to send the image data to the processor.

23. A method of manufacturing a movable layer in an electromechanical systems device, the movable layer having an actuated position and a relaxed position, comprising:
forming a support structure over a substrate;
forming a movable layer over the support structure and the substrate, wherein forming the movable layer includes forming a mirror layer, forming a dielectric layer over the mirror layer, and forming a cap layer over the dielectric layer, the mirror layer on a side of the movable layer facing the substrate; and
wherein forming the movable layer includes configuring the movable layer to have a curvature in a direction away from the substrate when the movable layer is in the relaxed position.

24. The method of claim 23, wherein forming the movable layer includes forming the mirror and cap layers such that the mirror and cap layers each have a tensile stress, and wherein the tensile stress of the mirror layer is greater than the tensile stress of the cap layer so as to curve the movable layer in a direction away from the substrate when the movable layer is in the relaxed position.

25. The method of claim 23, wherein forming the movable layer includes forming cuts in the cap layer for reducing a stress of the cap layer relative to a stress of the mirror layer so as to curve the movable layer in a direction away from the substrate when the movable layer is in the relaxed position.

26. The method of claim 23, wherein forming the movable layer includes forming the mirror layer with a thickness dimension that is greater than a thickness dimension of the cap layer so the configuration of the movable layer curves the movable layer in a direction away from the substrate when the movable layer is in the relaxed position.

27. The method of claim 26, wherein the mirror layer has a thickness dimension that is greater than a thickness dimension of the cap layer by a factor ranging between about 1.0 and about 1.2.

28. The method of claim 26, wherein a thickness dimension of the mirror layer is greater than a thickness dimension of the cap layer by about 50 Å to about 100 Å.

29. The method of claim 26, wherein the mirror layer has a thickness dimension of between about 250 Å and about 650 Å, and the cap layer has a thickness dimension of between about 200 Å and about 600 Å.

30. The method of claim 23, wherein the reflective layer and the cap layer are formed from substantially the same material.

31. The method of claim 23, wherein at least one of the reflective layer and the cap layer include aluminum-copper (AlCu).

32. The method of claim 23, wherein the dielectric layer includes at least one of silicon oxynitride (SiON) and silicon dioxide (SiO₂).

33. The method of claim 23, wherein forming the movable layer includes forming the mirror layer to have a compressive stress, and wherein forming the movable layer further includes forming cuts in the mirror layer for reducing a magnitude of the compressive stress of the mirror layer so as to curve the movable layer in a direction away from the substrate when the movable layer is in the relaxed position.

34. The method of claim 23, wherein forming the movable layer includes forming the mirror and cap layers such that the mirror and cap layers each have a compressive stress, and wherein a magnitude of the compressive stress of the mirror layer is less than a magnitude of the compressive stress of the cap layer so as to curve the movable layer in a direction away from the substrate when the movable layer is in the relaxed position.

35. The method of claim 23, further comprising providing a sacrificial layer over the substrate before forming the movable layer, and removing the sacrificial layer using an etchant to form the gap.

36. An electromechanical systems device, comprising:
a substrate; and
a movable layer spaced from the substrate and defining one side of a gap between the movable layer and the substrate, wherein the movable layer is movable in the gap between an actuated position and a relaxed position, and wherein the movable layer includes means for directing the curvature of the movable layer in a direction away from the substrate when the movable layer is in the relaxed position such that a portion of the movable layer above a center of a pixel of the device is displaced from the substrate by about 10 nm to about 30 nm more than an average distance between the movable layer and the substrate over an optically active area of the device.

37. The electromechanical systems device of claim 36, wherein the curvature directing means includes a mirror layer, a cap layer, and a dielectric layer disposed between the mirror and cap layers, the mirror layer facing the substrate and having a thickness dimension greater than a thickness dimension of the cap layer.

38. The electromechanical systems device of claim 37, wherein the mirror layer has a thickness dimension that is greater than a thickness dimension of the cap layer by a factor ranging between about 1.0 and about 1.2.

39. The electromechanical systems device of claim 37, wherein a thickness dimension of the mirror layer is greater than a thickness dimension of the cap layer by about 50 Å to 100 Å.

40. The electromechanical systems device of claim 37, wherein the mirror layer has a thickness dimension of between about 250 Å and about 650 Å, and the cap layer has a thickness dimension of between about 200 Å and about 600 Å.

41. The electromechanical systems device of claim 36, wherein the curvature directing means includes a mirror layer, a cap layer, and a dielectric layer disposed between the mirror and cap layers, the cap layer including cuts for reducing a stress of the cap layer relative to a stress of the reflective layer such that the movable layer curves in a direction away from the substrate.

42. The electromechanical systems device of claim 36, wherein the curvature directing means includes a mirror layer, a cap layer, and a dielectric layer disposed between the mirror and cap layers, the mirror layer facing the substrate, wherein the mirror and cap layers each have a tensile stress, wherein the tensile stress of the mirror layer is greater than the tensile stress of the cap layer.

43. The electromechanical systems device of claim 36, further comprising a stationary electrode disposed over the substrate, wherein the movable layer is movable in the gap between the actuated position and the relaxed position by application of a voltage between the stationary electrode and the movable layer.

44. The electromechanical systems device of claim 36, wherein the curvature directing means includes a first layer and a second layer, wherein the second layer is disposed on a side of the first layer opposite the substrate, and wherein the first layer has a stress that is greater than a stress of the second layer such that the movable layer has a stress gradient that increases toward the substrate.

45. The electromechanical systems device of claim 44, wherein the first layer is a first dielectric sub-layer of the movable layer and the second layer is a second dielectric sub-layer of the movable layer.

46. A method of manufacturing a movable layer in an electromechanical systems device, the method comprising:
forming a sacrificial layer over a substrate; and
forming a movable layer over the sacrificial layer and the substrate, wherein forming the movable layer includes forming a first layer over the sacrificial layer and a second layer over the first layer, wherein the first layer has a stress that is greater than a stress of the second layer such that the movable layer has a stress gradient that increases toward the substrate.

47. The method of claim 46, further comprising removing the sacrificial layer, wherein the movable layer is configured to curve in a direction away from the substrate when the sacrificial layer is removed based on the stress gradient.

48. The method of claim 46, wherein the first layer is a first dielectric sub-layer of the movable layer and the second layer is a second dielectric sub-layer of the movable layer.

49. The method of claim 48, wherein forming the movable layer further includes forming a third dielectric sub-layer over the second dielectric sub-layer, wherein the third dielectric sub-layer has a stress that is less than the stress of the second dielectric sub-layer.

50. The method of claim 48, wherein forming the movable layer further includes forming a mirror layer before forming the first layer and forming a cap layer after forming the second layer.

51. The method of claim 46, wherein the first layer is a mirror layer and the second layer is a cap layer.

52. The method of claim 51, wherein the first layer is one of a metal layer and a dielectric layer and the second layer is the other of the metal layer and the dielectric layer.

53. The method of claim 46, wherein forming the movable layer further includes forming a third layer between the first and second layers, wherein the third layer has a stress than is greater than the stress of the second layer but less than the stress of the first layer.
